(19) United States
(12) Patent Application Publication
(10) Pub. No.: US 2015/0312627 A1
(43) Pub. Date: Oct. 29, 2015

(54) METHOD AND APPARATUS FOR CREATING CHANNELS

(71) Applicant: THOMSON LICENSING, Issy de Moulineaux (FR)

(72) Inventor: Regine Jeanne Lawton, Newbury Park, CA (US)

(21) Appl. No.: 14/690,017

(22) Filed: Apr. 17, 2015

Related U.S. Application Data
(60) Provisional application No. 61/984,937, filed on Apr. 28, 2014.

(51) Int. Cl. H04N 21/458; H04N 21/25

(52) U.S. Cl. CPC H04N 21/458; H04N 21/252

(57) ABSTRACT

A method for managing content commences by first creating a content channel for content of a particular genre responsive to a request from a first user. Thereafter, at least one other user is invited to access the created channel. The created channel is then automatically populated with content of the particular genre from at least one of a content source or the at least one other user.

### TECHNICAL FIELD

This invention relates to a technique for creating channels that provide access to content according to user preferences.

### BACKGROUND ART

Content delivery networks, such as those operated by cable television providers, satellite television purveyors, as well over the top content providers such as the M-Go content delivery service from Technicolor, Culver City, Calif., and telecommunication companies provide users of such networks a plethora of audio-visual content, such as movies and television programs. The content delivery network operators typically provide such content via hundreds of separate channels, many of which cater specific interests, such as sports, home improvement, history, drama, romance, and the like. Traditionally, the term “channel” referred to a frequency band over which a terrestrial broadcast station transmitted programming Today, the term has a broader meaning and includes traditional channels as well as other mechanisms via which a user obtains content and could include an Internet URL or other well-known technique for enabling access to content sources. The large number of available channels can overwhelm users who incur difficulty organizing content related to a particular preference.

Thus, a need exists for a technique for enabling network users to personalize content relevant to them and their interests.

### BRIEF SUMMARY OF THE PRESENT PRINCIPLES

Briefly, in accordance with an aspect of the present principles, a method for managing content commences by first creating a content channel for content of a particular genre responsive to a request from a first user. Thereafter, at least one other user is invited to access the created channel. The created channel is then automatically populated with content of the particular genre from at least one of a content source or the at least one other user.

### BRIEF DESCRIPTION OF THE DRAWINGS

FIG. 1 depicts a block schematic diagram of an exemplary system for delivering content to users

FIG. 2 depicts a block schematic diagram of an exemplary first device for receiving content from the system of FIG. 1;

FIG. 3 depicts a block schematic diagram of an exemplary second screen device for receiving content from the system of FIG. 1;

FIG. 4 depicts a screen shot of a Graphical User Interface (GUI) for managing content delivery to users of the system of FIG. 1;

FIG. 5 depicts in flow chart form a method for create and managing personalized channels in accordance with the present principles; and

FIG. 6 depicts a screen shot of a portion of the GUI of FIG. for enabling a user to create and manage personal channels using the method of FIG. 5.

### DETAILED DESCRIPTION

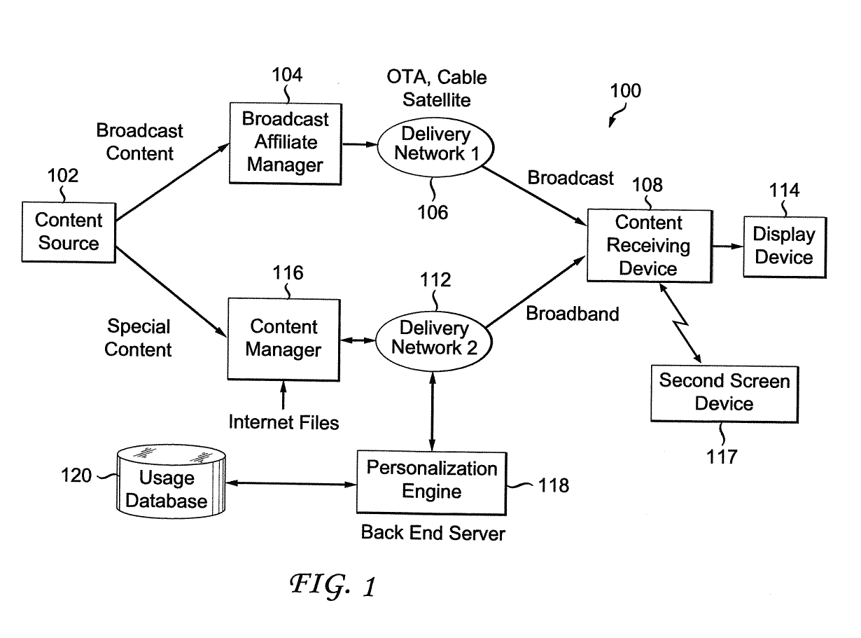

FIG. 1 depicts a block diagram of an illustrative embodiment of a system 100 for delivering content to a user (not shown), and in particular, for delivering content via personalized channels in accordance with the present principles. Such content typically comprises one or audio-visual presentations, including, but not limited to movies, television programs, streaming video or games, for example, that originate from a content source 102 which can deliver content in at least two forms. For example, the content source 102 can deliver content in the form of “broadcast” content of the type formatted for terrestrial broadcast by a broadcast affiliate manager 104, typically a national television broadcast network, such as those operated by American Broadcasting Company (ABC), National Broadcasting Company (NBC), Columbia Broadcasting System (CBS), etc. The broadcast affiliate manager 104 can collect and store the content, and can schedule delivery of that content over a delivery network 106, which can include a wired or wireless communications network or a combination of over-the-air (OTA), cable television and/or satellite communication networks.

The content source 102 can also deliver special content, such as premium or pay-per-view content otherwise not provided to the broadcast affiliate manager 104. For example, such special content can include first run movies offered to users in response to their request (e.g., pay-per-view), or on a subscription basis. Such content can also include archived episodes of television shows provided to the broadcast affiliate manager 104. The content source 102 provides such special content to a content manager 110, which can comprise a service provider, such as an Internet website, affiliated with a content provider, broadcast service, or network delivery service (e.g., cable television or satellite provider or telecommunications carrier). The content manager 110 can also incorporate Internet files for delivery with such special content through an over the top service such as , Netflix, Amazon and the M-GO content delivery service from Technicolor, Inc. as an example. In practice, the content manager 110 delivers special content (and associated Internet files) over a separate delivery network 112, which can include a Wide-Area Network (WAN), Local-Area Network (LAN) and/or a high-speed broadband communications network, including, but not limited to, the Internet. Note that the content provided by the broadcast affiliate manager 104 could undergo delivery using all or part of delivery network 112 and content from the content manager 110 could undergo delivery using all or part of delivery network 106. In addition, the delivery of content could occur directly via the network 112 without the need for the content manager 110.

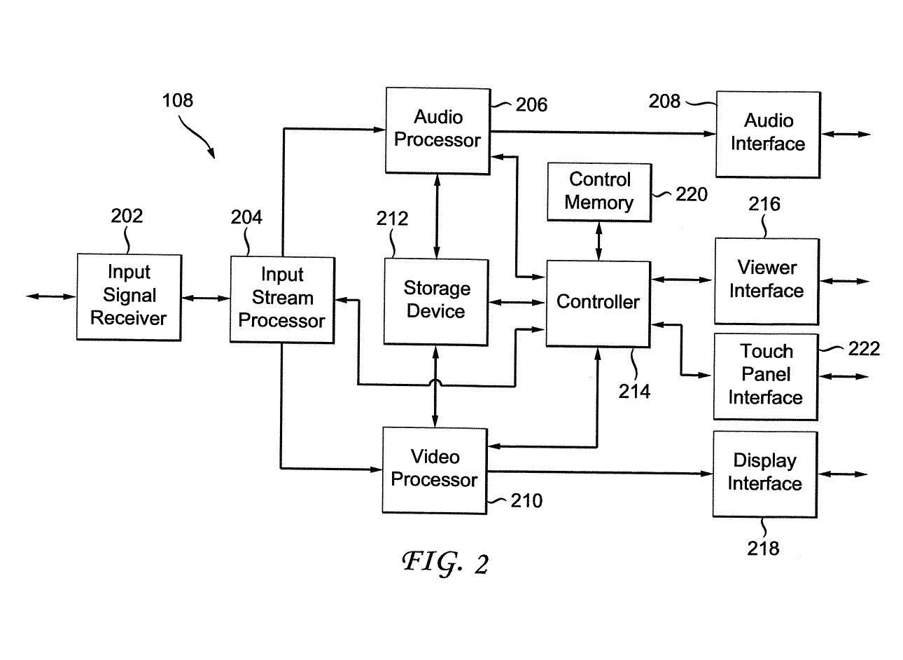

At a local premise, such as a home or the like, a user of the content delivery networks 106 and 112 (e.g., a “viewer”) uses a content receiving device 108 to access (e.g., receive) content via one or both of the networks for processing and subsequent display on a display device 114, such as a television set or the like. In this way, the network user “consumes” content. The content receiving device 108, described greater in detail in FIG. 2, can take many forms, such as a set-top box, gateway, modem or the like. Moreover, the functionality of the content receiving device 108 could reside in devices such as a digital video player (DVR), personal computer, television set, etc. or could take the form of a set top box/digital video recorder (DVR), a gateway, a modem, etc. Further, the content receiving device 108 could act as entry point, or gateway, for a home network system (not shown) that includes additional devices configured as either client or peer devices in the home network (not shown).

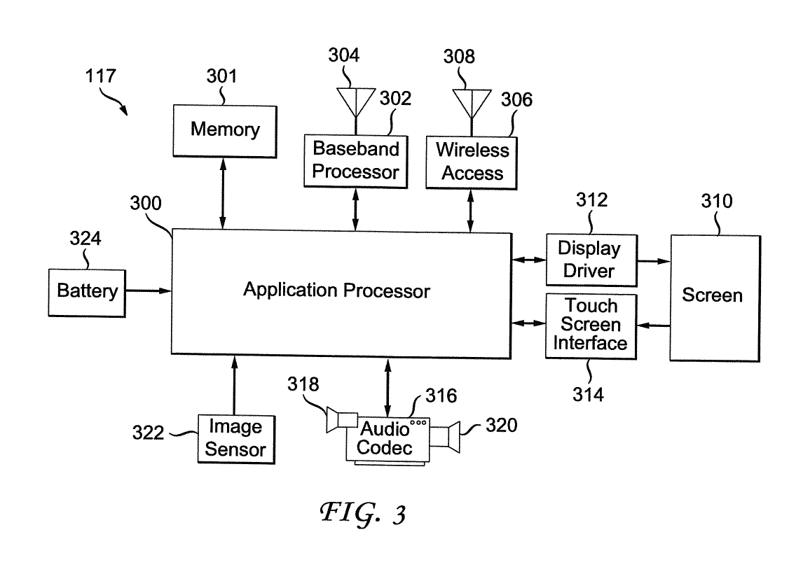

The content receiving device 108 processes the content received via one or both the networks 106 and 112 based on user preferences and commands. The content receiving device 108 can include a storage device, such as a hard drive or optical disk drive (not shown), for content recording and playback. The content receiving device 108 can interface with a second-screen device 117, described in detail with respect to FIG. 3. The second-screen device 117 allows the user to control both the content receiving device 108 and the display device 114. Further, the second-screen device 117 also has the capability to display the same or related content in synchronism with the content displayed on the display device 114. The second-screen device 117 allows the user to interact with the content. For subsequent reference, the content receiving device 108 constitutes a “first” content receiving device, whereas the second-screen device 117 constitutes a “second” content receiving device.

The system 100 includes a back-end server 118 and a usage database 120. The back end server 118 performs the function of a personalization engine that analyzes the usage habits of users and makes recommendations for content based on those habits. The usage database 120 stores user data indicate viewing habits and stores user profiles generated by the back-end server 118. The back-send server 118 can perform billing and/or authentication functions as well. Other mechanisms (not shown) could perform billing and/or authentication in place of the back-end server 118.

FIG. 2 depicts a block schematic diagram of an exemplary embodiment of the content receiving device 108 of FIG. 1. As illustrated in FIG. 2, the content receiving device 108 includes an input signal receiver 202 that receives content via the networks 106 and 112 shown in FIG. 1. The input signal receiver 202 can comprise one of several known receiver circuits used for receiving, demodulating and decoding received content. An input stream processor 204 receives the decoded content and performs the final signal selection and processing, including separation of video from audio in the decoded content. The input stream processor 204 supplies the audio to an audio processor 206, which generates an audio signal for receipt by an audio interface 208 that provides an audio signal to the display device 114 of FIG. 1, or other device(s) (not shown) for audio reproduction. Typically, the audio interface 208 generates an analog audio signal. Alternatively, the audio interface 208 could generate a digital signal. Additionally, the audio processor 206 supplies audio signals to a storage device 212 for storage.

The input stream processor 204 also provides a video output signal to a video processor 210, which undertakes signal conversion to provide a video signal of the appropriate format for storage in the storage device 212 and for display. A display interface 218 interfaces the video processor 210 to the display device 114 of FIG. 1. The storage device 212 stores content audio and video for later retrieval and playback of the content under the control of a controller 214 in accordance with commands received by the user through a user interface 216 and/or a touch panel interface 222. The user interface 216 can provide an interface to a touch panel (not shown) separate from, or integrated with the display device 114 of FIG. 1. Additionally, the user interface 216 provides the mechanism by which the second-screen device 117 of FIG. 1 interfaces to the controller 214. The storage device 212 can comprise be a hard disk drive, one or more large capacity integrated electronic memories, such as static RAM (SRAM), or dynamic RAM (DRAM), or an interchangeable optical disk storage system such as a compact disk (CD) drive or digital video disk (DVD) drive.

The controller 214 controls the operation of the content receiving device 108. To that end, the controller 214 has bus interconnection to the input stream processor 204, the audio processor 206, the video processor 210, the storage device 212, the user interface 216 and the touch panel interface 222. The controller 214 manages the conversion process for converting the input stream signal into a signal for storage on the storage device 212 and/or display. The controller 214 also manages the retrieval and playback of stored content.

The controller 214 also has a bus interconnection to a control memory 220 (e.g., one or more volatile and/or non-volatile memories, including RAM, SRAM, DRAM, ROM, Programmable ROM (PROM), flash memory, Electronically Programmable ROM (EPROM), electronically erasable Programmable ROM (EEPROM), etc.), for storing information and instruction code for the controller 214. The control memory 220 can also store a database of elements, such as graphic elements, for generating a graphical user interface for display to the user on the display device 114 of FIG. 1.

In practice, the second-screen control 117 can take a variety of forms. For example, the second-screen device 117 could take the form of a tablet device, such as the Apple I-Pad, or Samsung Galaxy Note tablet. Alternatively, the second-screen control 117 could take the form of a smart phone or laptop computer or any other similar device that can send and receive data as well as display of such data. A block schematic diagram of an exemplary second-screen device 117, in the form of a smart phone, appears in FIG. 3. The second-screen device 117 of FIG. 3 includes an application processor 300, which controls overall operation of the device. To that end, the application processor 300 has a connection to a memory block 301, which can include one or more of the following types of memory (not shown), flash card, mobile DRAM, Memory Multi Chip Package (MCP), and Multimedia Card Memory (MMC), which collectively store the operating system for the application processor as well as application programs and data.

The application processor 300 interfaces with a baseband processor 302, which connects to an antenna 304. The baseband processor 302 includes circuitry (not shown) for receiving and transmitting RF signals within the frequency range designated for cellular communication to allow the second-screen device 117 to operate as a cellular telephone for voice and/or data communication. The application processor 300 also interfaces with a wireless access block 306 that connects to an antenna 308. The wireless access block 306 operates in a manner similar to the baseband processor 302 to receive and transmit RF signals, except that the wireless access block operates in both the Bluetooth and Wi-Fi frequency band.

The second-screen device includes a display screen 310, typically an LCD or OLED screen, driven by the application processor 300 via a display driver circuit 312. In addition to its display functionality, the screen 310 has a data input capability to allow an operator to touch the screen to enter data to the application processor 300 via a touch screen interface 314. The application processor 300 interfaces with an audio codec 316 connected to a microphone 318 and a speaker 320. The audio codec 316 processes voice signals from the microphone 318 for receipt by the application processor 300 to allow the user of the second-screen device to enter voice commands as well as converse with another caller when the second-screen device operates as a cell phone. The audio codec also process signals from the application processor 300 for audio reproduction by the speaker 320.

In the illustrated embodiment, the second-screen device 117 of FIG. 3 also includes an image sensor, typically in the form of a CMOS image sensor 322, coupled to the application processor 300. In an optional embodiment, the image sensor 322 could be configured to accept user input in the form of gestures. The application processor 300 can store images captured by the image sensor 322 in the memory bank 301 for future recall and/or transmission by one of the baseband processor 302 or the wireless access block 306. A power source, in form of a rechargeable battery provides power to the application processor 300 for its use and for distribution to the other elements within the second-screen device 117.

In practice, the wireless access block 306 of the second-screen device 117 of FIG. 3 advantageously communicates with touch panel interface 222 of the content receive device 108 of FIG. 2 via a Wi-Fi channel although the second-screen device 117 could use Bluetooth instead of Wi-Fi as the communications protocol. In this way, a user using the second-screen device 117 of FIG. 3 can enter commands via the touch screen functionality of the screen 310 to control the content receiving device 108 while viewing content displayed on the screen 310. In addition, the user using the second-screen device 117 could also enter voice commands through the microphone 318 to control the content receiving device 108 of FIG. 2.

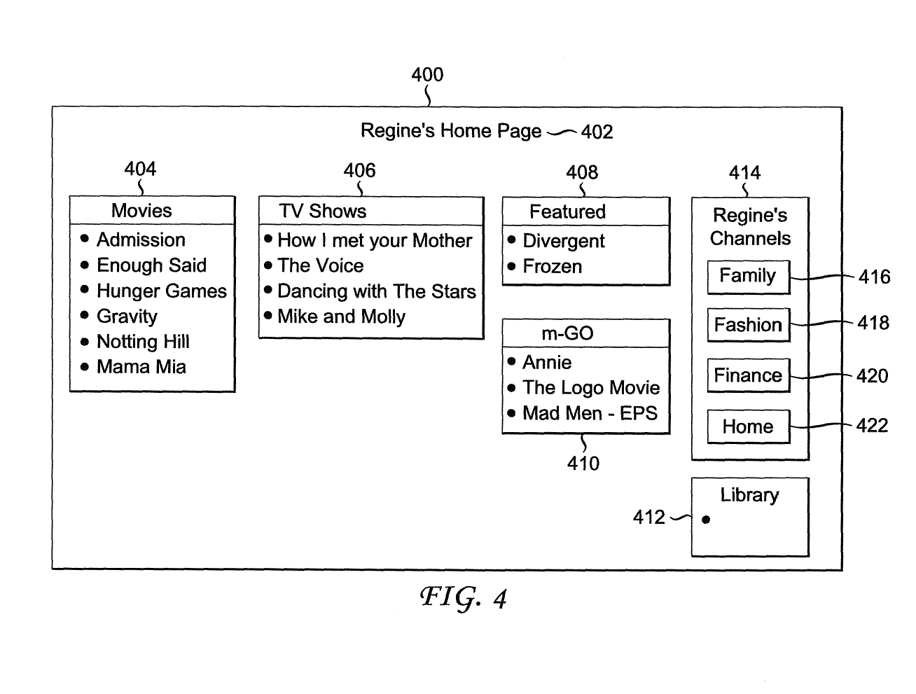

In accordance with an aspect of the present principles, the back-end server 118 of the system 100 of FIG. 1 can create and automatically populate one or more personalized viewing channels for users based on user input commands, thereby allowing users to access content in accordance with personal preferences. To understand better the manner in which the system 100 of FIG. 1 manages personalized viewing channels, refer to FIG. 4, which depicts a screen shot of a user interface 400 of a typical content consumer (“Regine”) that receives content via one or both of the networks 106 and 112 (both of FIG. 1). The user interface 400 of FIG. 4 can appear on either or both of the devices 108 and 117 of FIG. 1 and serves as a Graphical User Interface via which the user creates and manages such personal channels.

Referring to FIG. 4, the user interface has a heading 402 that identifies the user (e.g., “Regine's User interface”). In addition to the heading 402, the user interface 400 typically includes one or more icons, each associated with a different source of content for accessing content. In the illustrative embodiment of FIG. 4, the user interface 400 includes icons 404-414. The icon 404 corresponds to a “Movies” portal via which the user can access different movies illustratively depicted by the movies Admissions, Enough Said, Hunger Games, Gravity, Notting Hill, and Mamma Mial. The movies accessed through the “Movies” portal could exist as stored files resident in the content receiving device 108 of FIG. 1 or another storage device (not shown) at the user premise. Alternatively, one or more of these movies listed in the “Movies” portal could exist as a link which, when actuated by the user would trigger an appropriate one of the networks 106 and 112 of FIG. to either stream or download the requested movie from one or storages devices available to the networks or from other content sources (not shown).

Various mechanisms exist for populating the “Movies” portal. For example, the content manager 116 of FIG. 1 could communicate a list of available movies to the back-end server 118 of FIG. 1 for inclusion in the “Movies” portal. In addition, the back-end server 118 could select additional movies from the content manager 116 for inclusion in the “Movies” portal, taking into account the user viewing habits. Further, the user could request movies from the content manager 116, via the Internet or another communications channel, for inclusion in the “Movies” portal.

The icon 406 designates a “TV Shows” portal via which the user “Regine” can access episodes of television shows, such as How I Meet Your Mother, The Voice, Dancing with the Stars and Mike & Molly, for example. These television show episodes (as well as episodes of other shows) could exist as stored files resident in the content receiving device 108 of FIG. 1. Alternatively, these television show episodes could exist as links which, when actuated by the user would trigger streaming or downloading of these episodes as requested.

Various mechanisms exist for populating the “Television Shows” portal. For example, the content manager 116 of FIG. 1 could communicate a list of available television show episodes movies to the back-end server 118 of FIG. 1 for inclusion in the “Television Shows” portal. In addition, the back-end server 118 could select additional television shows from the content manager 116 for inclusion in the “Television Shows” portal, taking into account the user viewing habits. The content manager typically provides such shows via it's own storage device(s) or from other sources. Further, the user could request different television show episodes from the content manager 116, via the Internet or another communications channel for inclusion in the “Television Shows” portal.

The icon 408 designates a “Featured” portal via which the user “Regine” can access featured content. As illustrated in FIG. 4, the “Featured” portal identified by the icon 408 provides the user with access to two first-run movies Divergent and Frozen. Unlike the portals associated with the icons 404 and 406, which typically confine themselves to movies and television shows, respectively, the portal associated with the icon 408 provides access to variety of featured content including but not limited to first-run movies. Such featured content could include steaming video, games and/or other content (e.g., e-books for example) in addition to, or in place of featured movies and television show episodes. The content accessible via the “Featured” portal associated with the icon 408 could exist as stored files resident in the content receiving device 108 of FIG. 1. Alternatively, the content could exist as links which, when actuated by the user would trigger streaming or downloading the featured content as requested. The mechanisms discussed above for populating the other portals could also apply to populating the “Featured” portal as well.

The icon 410 corresponds to a portal via which the user “Regine” can access content from an Over-the-Top (OTT) content provider as embodied in the form of a content manager 116 in accordance with the illustrative principles disclosed above. For example, the M-Go content delivery service from Technicolor, Culver City California is an example of an OTT service provider. For this reason, the portal associated with the icon 410 bears the identification “M-GO.” As illustrated in FIG. 4, the M-Go service has a user screen that allows the user to access content from the M-Go content delivery service, as illustratively depicted by the movies Annie and The Lego Movie as well as an episode from the television show Mad Men. The content associated with the M-GO user screen typically exists as links, which, when actuated by the user would trigger streaming of the requested content. Typically, the M-GO content delivery services populates the M-GO portal in response to user content requests received via the Internet or another communications channel,

The user interface 400 of FIG. 4 also includes an icon 412 associated with a “Library” portal via which the user can access content stored on the content receiving device 108, or another storage device (not shown) directly accessible by the user. The illustrated embodiment of FIG. 4 depicts the “Library” portal as empty because the user has not yet designated any content for storage. Once the user does designate content for storage, the identity of the stored content will appear in the “Library” portal associated with the icon 412.

The icon 414 designates a “Personal Channel” portal via which a user can create, delete and otherwise manage personalized channels, exemplified by the channels represented by the icons 416-422 depicted in FIG. 4. Each personalized channel constitutes separate content repository, which the user can populate with content according to user interests. Further, in accordance with an aspect of the present principles, the user can create and manage personal channels with the assistance of the back-end server 118, with each channel providing access to content of a particular genre selected by the user. The back-end server 118 can automatically populate such channels with content from a content source based and/or with content from one or more other users invited to access such personal channel(s). In an exemplary embodiment, a channel can be populated with content that is stored in the content locker of the one or more invited users, when such users accept such an invitation. For example, the channel receives content from a Ultra Violet digital locker that is associated with one or more invited users.

In the illustrated embodiment of FIG. 4, the icons 416-422 designate the following personal channels “Family”, “Fashion”, “Finance”, and “Home”, respectively, created by the user “Regine.” Having created these channels designated by the icons 416-422, the user can then populate channels with content. For example, the user “Regine” could populate her

“Home” channel with content related to the home, such television show episodes related to home improvement and/or real estate, by making a request to the content manager 116 for such content. In addition to, or in place of such television show episodes, the user could populate the “Home” channel with how-to videos from YouTube or other sources by requesting such content from such sources. The user can populate each of the other channels with content related to the subject matter of such channels in a manner similar to that described for the “Home” channel. As discussed in detail below, the user (e.g., “Regine” in the current example) can invite one or more other users to access one or more of the personal channels. The user can user various mechanisms for sending such invitations. For example, the user could employ e-mail or could make use of a feature provided via the OTT network to invite other users on that network. Further, the user could issue such invitations via one or more social networks, for example Facebook, Twitter or Instagram by way of example. The invited user(s) can populate such channels with content (if so permitted by the user who created such channels) based on the genre associated with the created channel. Further, the invited user(s) can populate such channels with content based on comments from such invited users identifying the supplied content as relating to the genre of the personal channel. Lastly, the invited users can populate such personal channels based on metadata in the supplied content identifying the content as related to the genre of such personal channels. Different options allow the display of content to be done exclusively by source (Facebook, M-Go, ABC, CBS) exclusively by content type or genre, exclusively by when the content is broadcasted/released (content received Tuesday, Wednesday, Thursday), and/or exclusively by when the access privileges to the content expire (rental v. movie leaving Netflix due to a termination in a studio agreement).

As discussed above, invited users can populate personal channels based on metadata related to genre. However, the metadata, can also use other descriptive attributes of the content for making recommendations, including but not limited to: Actors, Titles, Directors, Year of Content Creation, Location of production, content rating, etc.

The back-end server 118 of FIG. 1 can automatically populate the personal channels created by the user (e.g., “Regine” in this example) with content based on the genre associated with such channels. Thus, for example, for the personal channel “Fashion”, the back-end server 118 of FIG. 1 would automatically populate that channel with programming related to fashion trends or even advertisements from clothing and accessory retailers as an example and not by way of limitation. The content associated with each personal channel could exist as stored files resident in the content receiving device 108 of FIG. 1. Alternatively, the content could exist as links which, when actuated by the user would trigger streaming or downloading the featured content as requested.

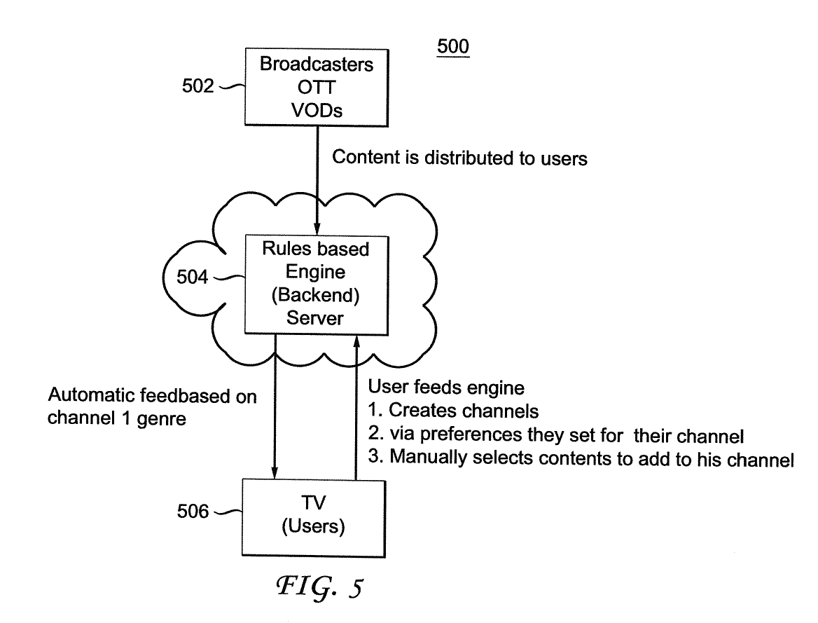

FIG. 5 depicts in flow-chart form the steps of a method 500 practiced by the system of FIG. 1 to enable the user to create and manage personalized channels. The method commences upon execution of step 502 at which time the user receives content from one or more Broadcasters, Over-the-Top providers, Video on Demand provider(s), cable television providers, satellite television providers, and telecommunications carriers, by way of example and not limitation. As the user consumes the content, the back-end server 118 of FIG. 1, which has a rules-based engine, will capture information from the user, including a request to create or modify a channel, create or change preferences for such channels as well user requests to add content manually to such channels, all during step 504. In response, the rules-based engine in the back end server 118 of FIG. 1 can automatically populate such channels during 506 with content related to the genre of the channels.

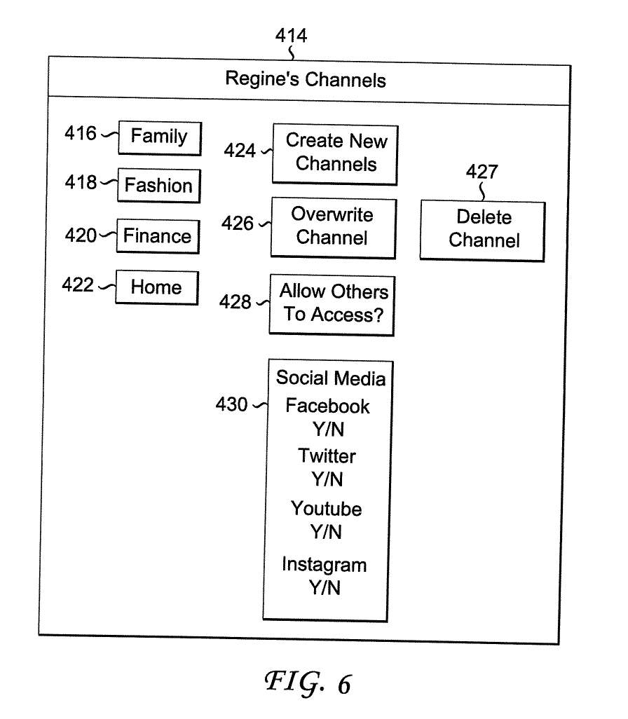

FIG. 6 depicts an expanded version of the icon 414 of FIG. 4 associated with the user's personalized channels. The expanded icon 414 includes the icons 416-422 depicting the user's personalized channels. Further, the icon 414 includes a set of icons 424-430 corresponding to functions utilized by the user to create and manage personalized channels.

The icon 424 displays the message “Create New Channel.” By actuating the icon 424, the user can create a new personalized channel. The user could use a remote control (not) shown for the content receiving device 108 of FIG. 1 to actuate the icon and subsequently designate the subject matter for that channel. Alternatively, the user could use the second-screen device 117 for this purpose.

The icon 426 displays the message “Overwrite Channel.” and by actuating this icon, the user can overwrite an existing personalized channel, e.g., the “Fashion” channel depicted by icon 422. The icon 427 displays the message “Delete Channel.” and by actuating this icon, the user can delete an existing personalized channel, e.g., the “Family” channel depicted by icon 416. The icon 428 displays the message “Allow Others Access” and by actuating this icon, the user can invite other users to access to one or more personalized channels. Such access could be unlimited or for a fixed duration. Users accessing other user's personal channels typically do not have permission to delete or overwrite personal channels. Only the user who created a personalized channel has the permission to overwrite or delete such a channel by actuating a corresponding one of the icons 426 and 427, respectively.

The icon 430 lists social media sites, which the user can authorize for access in connection with one or more of the user's personal channels. In the illustrated embodiment of FIG. 4, the icon 430 lists the following social media sites/content sharing sites for connection:
Facebook
Twitter
YouTube
Instagram
   Each listed social media site includes a designator “Y/N” which allows the user to authorize a connection to that site. While the icon 430 lists the four social media sites described above, the icon could list a larger or smaller number of sites without departing from the present principles.

As discussed above, the user can make use of one or social networks such as those listed in the icon 430 to invite other users to access one of the user's personal channels. The user could user other mechanisms as well, including but not limited to e-mail. Further, as discussed previously, the other user(s), once invited, can upload content to the inviting user's personal channels.

The foregoing describes a technique for managing personalized channels that provide access to content according to user preferences.

1. A method for managing content, comprising:
creating a content channel for content of a particular genre responsive to a request from a user;
inviting at least one other user to access the created channel; and
automatically populating the created channel with content of having a particular attribute from at least one of a content source or the invited at least one other user.

2. The method according to claim 1 wherein the at least one other user populates content to the created channel based on comments such populated content as relating to the attribute of the personal channel.

3. The method according to claim 1 wherein the invited users populate such personal channels based on metadata in the populated content identifying such content as related to the attribute of such personal channels.

4. The method according to claim 1 wherein the at least one user is invited via an e-mail.

5. The method according to claim 1 wherein the at least one user is invited via a social network.

6. The method according to claim 1 wherein the user can delete the created channel.

7. The method according to claim 1 wherein the user can overwrite the created channel.

8. The method according to claim 1 wherein the user can overwrite content in the created channel.

9. A system for managing content delivery to users, comprising,
at least one source of content;
at least one content delivery source for delivering content to a content user;
a server coupled to the content delivery network for (1) creating a content channel for content of a particular genre responsive to a request from a user; (2) inviting at least one other user to access the created channel; and (3) automatically populating the created channel with content of the particular genre from at least one of a content source or the at least one other user.

10. The system according to claim 9 wherein the server populates content to the created channel from the invited at least one other user based on comments such populated content from the invited at least one other user relating to the genre of the personal channel.

11. The system according to claim 9 wherein the server populates content to the created channel from the invited at least one other based on metadata in the populated content identifying such content as related to the genre of such personal channels.

12. The system according to claim 9 wherein the server invites at least one other user via an e-mail.

13. The system according to claim 9 wherein the server populates content to the created channel from the invited at least one other user via a social network.

14. The system according to claim 9 wherein the server deletes the created channel in response to a user command.

15. The system according to claim 9 wherein the server overwrites the created channel in response to a user command.
